(19) United States
(12) Patent Application Publication
(10) Pub. No.: US 2018/0357666 A1
(43) Pub. Date: Dec. 13, 2018

(54) ADVERTISEMENT FOLLOW UP

(71) Applicant: Google Inc., Mountain View, CA (US)

(72) Inventors: Justin Lewis, Marina Del Rey, CA (US); Ruxandra Georgiana Paun, Santa Monica, CA (US)

(73) Assignee: Google Inc., Mountain View, CA (US)

(21) Appl. No.: 14/230,685

(22) Filed: Mar. 31, 2014

(51) Int. Cl. G06Q 30/02

(52) U.S. Cl. CPC G06Q 30/0251; G06Q 30/0261

(57) ABSTRACT

An advertising method includes receiving by a processor, an indication that an ad is available for display on a viewer's media device; determining by the processor that the viewer has favorably reacted to or interacted with the ad; determining by the processor that the media device meets requirements for receiving notification files; sending by the processor the favorable determination and eligible status to a remote server; receiving by the processor a notification file from remote server and storing in memory on the media device; detecting by the processor, occurrence of a triggering event at the media device; and displaying content of the notification file at the media device.

### BACKGROUND

Video program providers often provide video programs (or simply videos) with one or more video or static advertisements that may be displayed before the video plays (a pre-roll ad), during play of the video (an overlay or instream ad), or after the video plays (post-roll ad). The video program provider may include an ad skip or dismiss feature. Ad skip features may allow a viewer to skip an ad after a specified time (e.g., five seconds) or at any time. Ad dismiss features allow the viewer to dismiss the ad at any time. Not all ads can be skipped or dismissed. Skipped ads and dismissed ads may be assessed as not of interest to the viewer, and an advertiser may not have to pay for skipped ads.

### SUMMARY

An advertising method includes receiving by a processor, an indication that an ad is available for display on a viewer's media device; determining by the processor that the viewer has favorably reacted to or interacted with the ad; determining by the processor that the media device meets requirements for receiving notification files; sending by the processor the favorable determination and eligible status to a remote server; receiving by the processor a notification file from remote server and storing in memory on the media device; detecting by the processor, occurrence of a triggering event at the media device; and displaying content of the notification file at the media device.

A system for serving advertisements on a Web page, determining viewer interest in the advertisements, providing notifications to the viewer, and determining and reporting interactions by the viewer with the interactions includes a processor; and a computer-readable storage medium having instructions for serving advertisements. The processor executes the instructions to determine that a viewer's media device is being used to access an Internet Web page; determines the viewer selects a video for viewing, where an advertisement is displayed with display of the video; determines the viewer interacts favorably with the advertisement; determines the viewer watches the video; adds an event, a notification, and a viewer ID to an event map and stores the event map; adds an event listener to the viewer's media device; receives a detection of detects a triggering event from the event listener; searches the event map by event and retrieves the notification and viewer ID; syndicates the notification as a notification file to media devices registered to the viewer by viewer ID; and receives a signal that the viewer interacted with the notification file.

An advertising method includes receiving from an advertiser at a processor a bid for advertising inventory in which skippable and non-skippable ads are implemented and in which notifications may be sent to individual viewers based on the viewer's interactions with the skippable and non-skippable ads; determining by the processor that the viewer reacted favorably to an ad and that follow on notification, including use of a notification file to be sent to the viewer's media device, is enabled; receiving a statement from the processor that the ad inventory refers to a notification ad, and prompting the advertiser to increase its bid amount; receiving by the processor an increased bid amount that wins the auction and assigning the notification ad to the ad inventory; and incrementing a counter that tracks a number of notification ads that a viewer may have in queue to account for the just-acquired notification ad.

### DESCRIPTION OF THE DRAWINGS

The detailed description refers to the following figures in which like numerals refer to like items, and in which:

FIGS. 1A-1C illustrate environments in which an advertisement system may be implemented and used;

FIG. 2A illustrates an example video player displaying skippable and non-skippable advertisements;

FIG. 2B illustrates an example media device on which advertisements may be served and displayed, and on which follow up notifications may be shown;

FIGS. 3A and 3B illustrate components of an example server-side system for serving and following up on advertisements; and

FIGS. 4-5 are flow charts illustrating example methods for serving and following up on advertisements.

FIGS. 6A and 6B are flow charts illustrating example methods for serving and following up on advertisements.

### DETAILED DESCRIPTION

Advertisements may be served in conjunction with display of a video. A video may be viewed on an Internet Web page. Such pages may be referred to as watch pages. The watch page may be accessed by a browser executing on a viewer's media device. The browser may include or may access a media or video player that actually shows the video. The video player may be downloaded from the video provider's Web site. The video player may be stored in or with the browser in the media device.

The advertisements that are served with the video may be video ads or static ads, for example. A viewer may have the option of skipping certain of these ads. Ads that may be skipped (“skippable ads”) may include mechanisms that allow the viewer to dismiss the ad at any time or upon meeting certain conditions. In an aspect, advertisements may be categorized as: (1) long video ads that can be skipped positioned at the beginning of the video, (2) short video ads positioned at the beginning of the video that cannot be skipped, and (3) ads that appear (pop-up) as an overlay on the video (e.g., at the bottom of the display) while the video is playing. Such overlay ads may appear at any time the video is playing; multiple overlay ads may appear at different times while the video is playing. Other advertisement types and categories are possible, including video ads shown at intermediary points during display of the video or after the video has completed playing.

However, in an aspect, any video ad may be skipped; for example, an ad without a skip ad feature may be skipped by closing a browser or navigating the browser to a new Web page.

A viewer's interest in an ad may be determined by measuring and evaluating if and how the viewer reacts to or interacts with the ad. Such reactions/interactions include skipping a video ad before completion or before a specified duration of the video ad, dismissing a static ad within a specified time from its initial display, and interacting with a video or static ad by, for example, clicking on the ad. For the skippable video ads at the beginning of videos, if a viewer skips the ad, the viewer may be considered to be not interested in the ad; if viewer watches the whole ad or clicks on the ad, the viewer may be considered to be interested in the ad. For non-skippable video ads at the beginning of videos, if a viewer does not interact with the video in any way, the viewer may be considered to be not interested in in the ad; if the viewer clicks on the ad, the viewer may be considered to be interested in the ad. For overlay ads at the bottom of the video, if the viewer dismisses the ad or leaves the ad alone, the viewer may be considered to be not interested in the ad; if the viewer clicks on the ad, the viewer may be considered to be interested in the ad.

In an aspect, a viewer may react to or interact with an ad, such as a video ad, while the ad is displayed to the viewer. In this aspect, the ad may be considered to have a lifetime that expires when the ad no longer is displayed. Thus, the lifetime of a particular ad displayed on or with a video may end when the video is ends; that is, the lifetime of the ad may end when the lifetime of its associated video ends. In an aspect provided by the herein disclosed systems and methods, an ad's lifetime may end for an ad for which the viewer has expressed no interest, when the video ends; for ads for which the viewer has expressed an interest, the herein disclosed systems and methods may extend the ad's lifetime beyond the lifetime of the associated video.

In an embodiment, the herein disclosed systems provide a mechanism a corresponding method for extending the lifetime of an ad. The mechanism and corresponding method may be implemented on a mobile media device of the viewer. The mechanism and corresponding method may include devices and processes for following up with a viewer for an ad for which the viewer showed an interest or reacted to/interacted with favorably. In an aspect of this embodiment, after the viewer expresses an interest in an ad, the viewer's mobile media device may signal the system. The signal may cause the system to syndicate a notification card. The notification card may be used to enable the system to follow up with the ad.

In an aspect, a notification card is a data file that may be sent to and stored in memory of the viewer's mobile media device(s). At a time subsequent to such syndication, the notification card may be displayed on a screen of the mobile media devices. This display may be time or location dependent. The notification cards may include an expiration feature. The expiration feature may automatically delete notification cards from memory, or may provide a dismissable prompt for the viewer to manually delete the notification card. The system may be used to determine a viewer's interest in a skippable ad, as stated above. The system also may be used to determine a viewer's interest in any advertisement, including any non-skippable video ad. For example, the system and method may determine that, during display of a video ad, a viewer does not scroll a video watch page, minimize the video watch page, mute the volume, or select a new tab. These “non-actions” by the viewer may serve as an indication the viewer reacted favorably to the non-skippable ad. Other techniques may be employed by the system to determine viewer favorability toward an ad.

In an example, a viewer may favorably react to or interact with a video ad by either watching the video all the way through or by clicking on the video ad while the ad is playing. In an aspect, the system may present the viewer with a specific soft button on the display of the video player, and may click on the button. Alternately, the system may employ eye tracking software to determine if the viewer responds favorably to the video ad.

A viewer need not watch a video ad in its entirety to be considered to have reacted favorably to the video ad. For example, a viewer may watch 75 percent of a video ad and still be considered to have reacted favorably to the video ad.

In an aspect, the system may detect when the viewer has scrolled the displayed watch page to the point where the video ad in not displayed (e.g., the viewer scrolls to an associated comments section of the watch page). If the video ad is out of view for a specified time, the viewer may be considered to be not interested in the video ad.

The system may use various mechanisms to trigger the viewer's mobile media device once a notification card has been syndicated. The trigger may cause display of information contained in the notification card. One such mechanism is based on the geographic location of the viewer's mobile media device. When the mobile media device is within a specified range of a retail store or movie theater, for example, or is near or within a predefined geo-spatial boundary, the mechanism may display the notification card. Another method of triggering the mobile media device is based on time after the notification card has been stored in memory. For example, a notification card for an upcoming movie (the ad may have been a movie trailer) is displayed on the day the movie comes out to prompt the viewer to purchase tickets. In an aspect, the notification card may include a mechanism to allow the viewer to purchase movie tickets. For example, the mechanism may be a link to a Web site where tickets can be purchased, and a corresponding scannable bar code can be downloaded to the viewer's mobile media device.

The location where a notification card is displayed is variable. In an embodiment, the notification card may be displayed on a home screen of a mobile media device. Alternately, the notification card may be displayed on a first page of a notification application that executes on the mobile media device. Finally, the notification card may be displayed as a text message or an email, or may be displayed according to a social network application.

The notification cards may not be delivered immediately to the mobile media device that triggers a notification event. For example, the system may be designed to limit a number of notification cards stored in memory of a mobile media device. Notification cards intended for a mobile media device of interest may be queued in a remote server, which is aware of a number of stored notification cards. The remote server may send the notification cards to the mobile media device when less than a threshold number of such cards is stored thereon and when the queued up notification card still is relevant (e.g., has not passed an expiration date).

In an aspect, all notification cards for a viewer are stored remotely and only are delivered to the viewer's media device(s) when a triggering event occurs and is reported to, or detected by the system. For example, a notification card may be delivered to the viewer's smart phone and tablet when the viewer (who is carrying the smart phone but not the tablet in this example) approaches a coffee shop whose advertisements the viewer previously viewed in their entirety.

Notification cards may be delivered to each media device the viewer has registered with a program publisher or other external service. A viewer may be able to access and view queued notifications. A viewer may dismiss a notification from the queue or from local memory.

In an aspect, the systems take advantage of wireless radio receivers used for communication that generally are present in mobile media devices and may utilize signal strength of other nearby fixed radios to determine the location of a mobile media device at any given time. For example, most media devices are WiFi and Bluetooth enabled. In addition, for many mobile media devices, cellular telephony radios can provide an additional axis of information. The systems may use a combination of these signals to provide the location of the mobile media device for purposes of triggering the notification card.

For example, to enable mobile media advertising and/or notification as a follow up to viewing an ad, the methods and systems provide a detection event when a mobile media device of interest detects the WiFi (or Bluetooth or Bluetooth Low Energy (BILE)) signal from an access point of interest. A mobile media device of interest may be a device that an advertiser wants to serve an advertisement—as, for example, a follow up to a previously viewed ad. A mobile media device of interest may have stored in memory, one or more notification cards that are triggered based on the geo-location of the mobile media device. A WiFi access point of interest may be an access point associated with or related to the subject matter of the advertisement to be served. As a part of a mobile media device advertising campaign, advertisements may be served on the mobile media device when the mobile media device approaches or crosses the WiFi access point of interest. For example, as a mobile media device approaches a coffee shop, the mobile media device may receive an advertisement for a latte. The advertisement may induce the operator of the mobile media device (i.e., the viewer) to enter the coffee shop and purchase the latte. Actual entry of the mobile media device into the coffee shop may be determined when the mobile media device crosses a WiFi-boundary centered on a WiFi access point established in the coffee shop. The entry may be determined at the mobile media device and then communicated to an ad server; alternately, the entry may be determined at the ad server. Furthermore, the entry may be recorded and reported as part of the viewer's behavior. This entry of the mobile media device into the coffee shop may be attributed to a recently viewed ad, and may be considered a conversion. Tying viewer actions to mobile advertisements may be an important aspect of the coffee shop owner's mobile media device advertising campaign.

In an alternative scenario, the operator/panelists may have recently viewed an advertisement for a latte, perhaps with a coupon offer, on a fixed media device, but an associated notification card is syndicated to each of the viewer's mobile media devices. Shortly after, the viewer approaches or enters the coffee shop as indicated by the WiFi access point detection. This trip to the coffee shop then may be attributed to the recently viewed coffee latte advertisement. The viewer may be presented with a 10 percent off coupon for a latte.

In these example scenarios, a coffee shop owner (i.e., an advertiser) wants to serve latte advertisements on certain mobile media devices. Note that in the herein disclosed systems, the mobile media device need not physically connect through the WiFi access point to the WiFi network; simply detecting the presence of the WiFi access point by the mobile media device may be sufficient to trigger display of the notification card.

Each WiFi access point will have a unique identifier. If the unique identifier (MAC address, service set identifier (SSID), or other identifier) for the access point is captured and logged by a location system on the mobile media device. A matching process may be performed locally on the mobile media device. This mobile media device-based matching process may involve uploading by the mobile media device of a match list of MAC addresses/SSID's corresponding to the WiFi access points of the stores of interest to a particular mobile media device. That is, when the notification card is stored in memory, the locations of associated facilities (e.g., movie theaters for a movie-based notification card) may be included with the data file that is, in effect, the notification card. Then, an application or system on the mobile media device, which has access to the WiFi data on the mobile media device, may extract the MAC address (or SSID) of any WiFi access points detected by the mobile media device. The application or system may run a match process to check the detected MAC addresses against the match list, and may provide a notification appropriate to the geo-location of the mobile media device.

In addition, the application may report matches to a remote server: store visit detected. The store visit detect signal may include a time stamp. However, the timestamp may be blurred (e.g., to a 3 hour period) and the specific store identification may be hidden or blurred (e.g., the mobile media device visited a store in the greater San Francisco area).

A viewer may view, react to, or interact with a number of ads, including video ads (e.g., movie trailers). Were each viewing or favorable reaction to or interaction with an ad to result in syndication of a notification card, the mobile media device, and the viewer, may be inundated with such notifications. To address this potential situation, the system may:

Flush notifications after expiration of a timer; Flush notifications at a threshold number, on a first in, first out basis; Flush notifications having a lower bid price than other notifications; Track a number of notifications for the mobile media device, and only send notification when the currently stored number of such notifications is less than a threshold amount; and

Set a pricing mechanism that requires a higher bid amount to display a notification ad; disable notification ads when a mobile media device has greater than a threshold number of notification in memory.

Set a pricing mechanism that requires an increasingly higher bid amount to add a notification to a viewer's queue of notification cards as the size of the queue increases.

The herein disclosed systems and methods may include pricing mechanisms that account for syndicating a notification card while at the same time preventing spamming. In an aspect, syndicating a notification card may require an advertiser pay an increase in price over an advertisement without a syndication feature, or for which syndication has been disabled. Examples of such fee structures include;

1) Flat additional fee in addition to the winning bid. This has the added benefit that the winning bid is still in the competitive range of advertisers' bids who are not adding notifications.

2) Increased minimum bid for advertisers who want to syndicate the notification card.

3) No change to bid.

4) Increased minimum bid based on the number of notifications the viewer already has against him. For example, if viewer A has already responded favorably to an advertisement which will spawn notifications, then showing an ad which will add an additional notification to viewer A will cost more than showing an ad to viewer B who has no notifications.

5) Not offering notification ads when a specific viewer has a notification queue that has reached a threshold size.

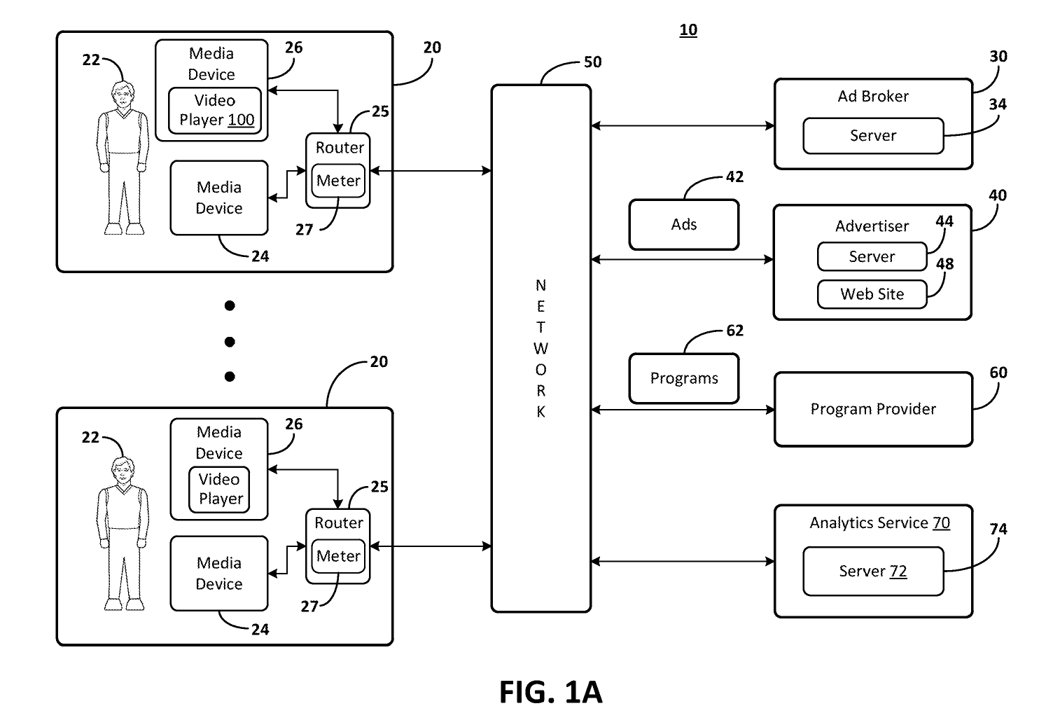

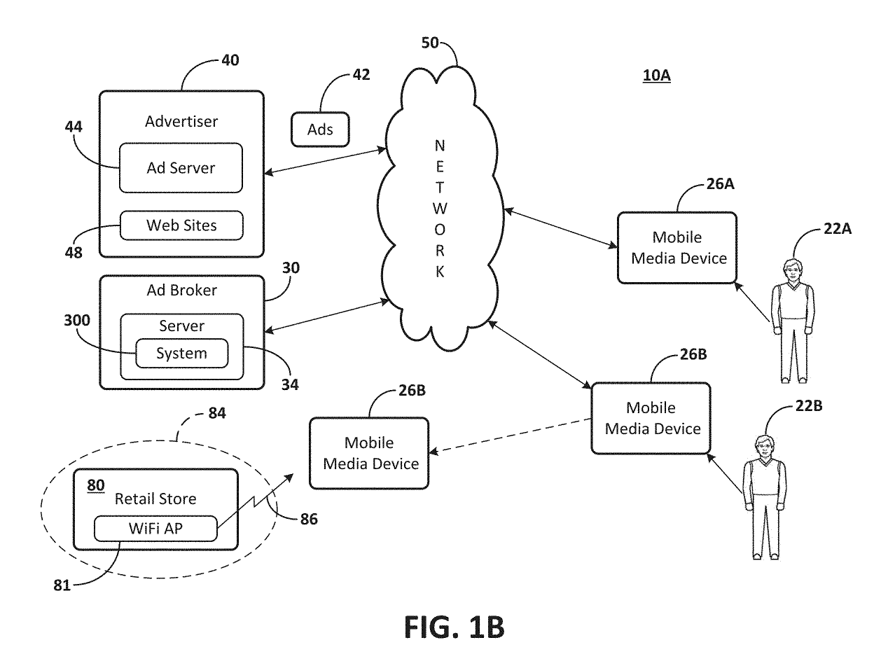

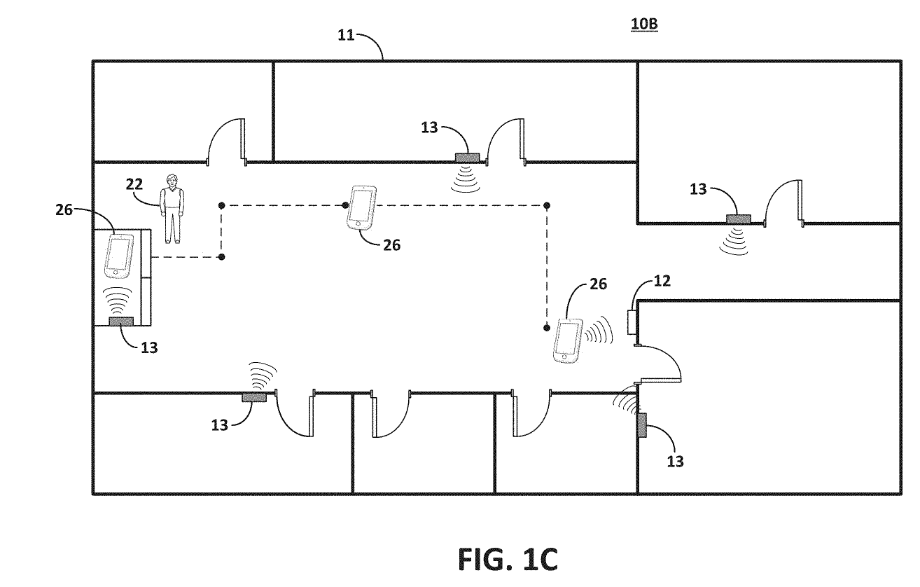

FIGS. 1A-1C illustrate environments in which an advertisement system may be implemented and used.

FIG. 1A illustrates an example environment in which advertisements may be served. In FIG. 1A, environment 10 includes viewing locations 20ᵢ, ad broker 30, advertisers 40, program provider (publisher) 60 and analytics service 70, all of which communicate using communications network 50. Although FIG. 1A shows these entities as separate and apart, at least some of the entities may be combined or related. For example, the ad broker 30 and analytics service 70 may be part of a single entity. Other entity combinations are possible.

The viewing locations 20ᵢ include first media devices 24ᵢ and second media devices 26ᵢ through which individuals 22i are exposed to media from advertiser 40 and program provider 60. A viewing location 20ᵢ may be the residence of an individual 22ᵢ who operates media devices 24ᵢ and 26ᵢ to access, through router 25ᵢ, resources such as Web sites and to receive broadcast and streaming television programs, radio programs, and other media. The media devices 24ᵢ and 26ᵢ may be fixed or mobile. For example, media device 24ᵢ may be an Internet connected smart television (iTV); a basic or smart television connected to a set top box (STB) or other Internet-enabled device; a Blu-ray™ player; a game box; and a radio, for example. Media device 26ᵢ may be a tablet, a smart phone, a laptop computer, or a desk top computer, for example. The media devices 24ᵢ and 26ᵢ may include browsers, (not shown). The browser may be a software application for retrieving, presenting, and traversing resources such as at the Web sites. The browser may record certain data related to the Web site visits. The media devices 24ᵢ and 26ᵢ also may include applications. The individual 22ᵢ may cause the media devices 24ᵢ or 26ᵢ to execute an application, such as a mobile banking application, to access online banking services. The application may involve use of a browser or other means, including cellular means, to connect to the online banking services.

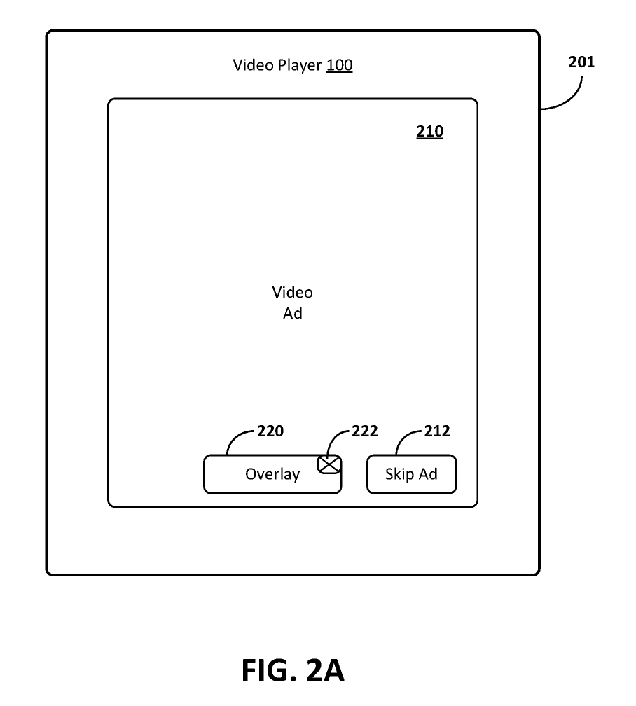

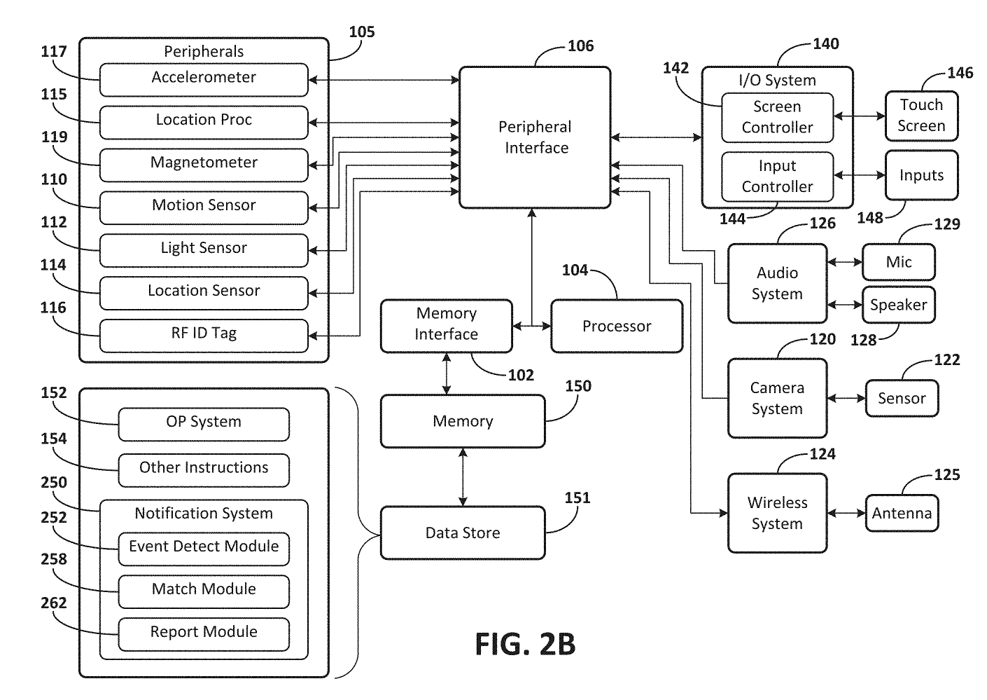

The media devices 24ᵢ and 26ᵢ may receive and store video players 100 through which video programs, and video and static advertisements are displayed for viewing by the individual 22ᵢ. The video players 100 may be incorporated into the browsers. The video players may be provided when the individual 22ᵢ downloads a video. The video players 100 are described in more detail with reference to FIG. 2.

The viewing location 20ᵢ may include a meter 27ᵢ that records and reports data collected during exposure of advertisements 42 and programs 62 to the individual 22ᵢ. The example meter 27ᵢ may be incorporated into the router 25ᵢ through which all media received at the viewing location 20ᵢ passes. Alternately, the individual 22ᵢ may operate separate meters (not shown) for each media device. The meter 27ᵢ may send the collected data to the analytics service 70. In lieu of or in addition to data collection by meter 27ᵢ, a STB, when implemented, may record data such as programs and advertisements watched data. The STB may send the data logs to the program provider 60 or analytics service 70.

The determination of which advertisement 42 to serve with which program 62 may depend in part on information related to the individual 22ᵢ at the viewing location 20ᵢ. This information may be provided by the individual 22ᵢ voluntarily. For example, an individual 22ᵢ may register with the program provider 60 and subscribe to a video delivery service provided by the program provider 60, and may provide information such as a password and user ID. The individual 22ᵢ further may agree to provide certain demographic data, such as age and gender. The individual also may agree to serve as a panelist, and may provide data to the service (e.g., analytics service 70) operating the associated panel.

In situations in which the systems disclosed herein collect personal information about the individuals 22ᵢ, or may make use of personal information, the individuals 22ᵢ may be provided with an opportunity to control whether programs or features collect individual information (e.g., information about an individual's social network, social actions or activities, profession, an individual's preferences, or an individual's current location), or to control whether and/or how to receive advertisements that may be more relevant or of interest to the individual. In addition, certain data may be treated in one or more ways before it is stored or used, so that personally identifiable information is removed. For example, an individual's identity may be treated so that no personally identifiable information can be determined for the individual 22ᵢ, or an individual's geographic location may be generalized where location information is obtained (such as to a city, ZIP code, or state level), so that a particular location of an individual 22ᵢ cannot be determined. Thus, the individual 22ᵢ may have control over how information is collected about the individual 22ᵢ and used by a server.

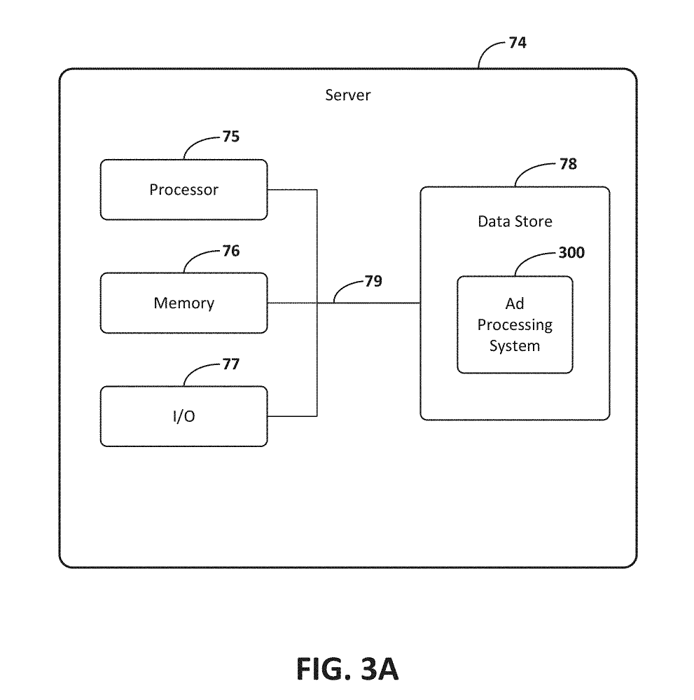

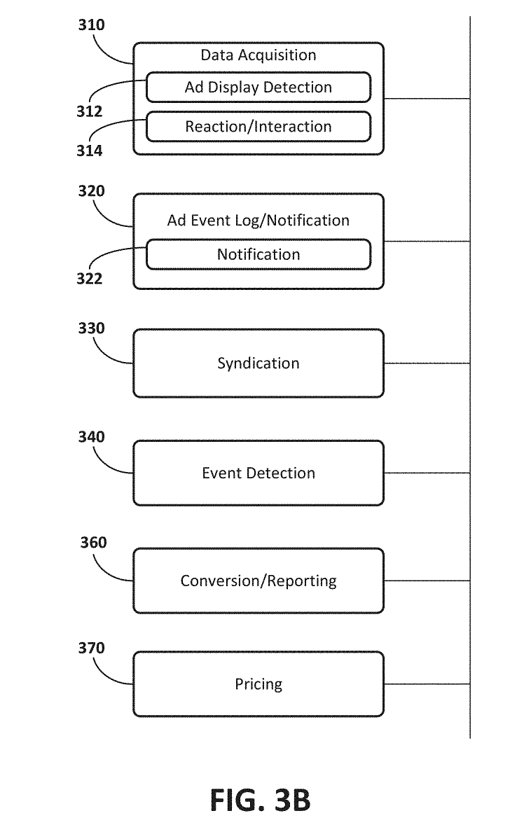

The ad broker 30 provides an advertisement service, executed as advertisement system 300 on server 34. The ad broker 30 operates server 34 to assign advertisements to advertising inventory provided by program provider 60. Operation of the advertisement system 300 is described in detail with respect to FIGS. 3a and 3B.

The advertiser 40 operates server 44 to provide advertisements 42 that are served with programs 62 provided by the program provider 60. For example, the server 44 may provide advertisements 42 to serve at Internet Web pages, in applications executing on the media devices 24ᵢ and 26ᵢ, and in breaks in broadcast television programs. The advertiser 40 may operate Web site 48. The advertiser 40 may represent a single company or entity, a group of related companies, or a group of unrelated companies.

The network 50 may be any communications network that allows the transmission of signals, media, messages, voice, and data among the entities shown in FIG. 1A, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless.

The program provider 60 delivers programs for consumption by the individuals 20ᵢ. In an aspect, the program provider 60 may operate server 64 to provide the programs 62. The programs 62 may be broadcast television programs, radio programs, Internet Web sites, or any other media or resource. The programs 62 include provisions for serving and displaying advertisements 42. The program provider 60 may receive the advertisements 42 from the advertiser 40 and incorporate the advertisements 42 into the programs 62. Alternately, the individual's media device may request an advertisement 42 when the media device displays a program 62.

The analytics service 70, which operates analytics server 74, may collect data related to advertisements 42 and programs 62 to which an individual 22; is exposed. In an embodiment, such data collection is performed through a system that receives data collected by the meters 27ᵢ. Alternately, or in addition, the data may be collected through surveys, set top boxes and other data logging mechanisms such as registration with the program provider 60. The collected data may be sent to and stored in analytics server 74, which then may process the data, store the results of the processing, and may report the results to another entity such as the ad broker 30 or the advertiser 40.

FIG. 1B illustrates an example environment in which advertisements may be served, viewed, and used for later follow up processes. The environment of FIG. 1B illustrates mobile media device monitoring, including geo-locating, when the mobile media device is away from, or outside of a viewer's residence, for example. The environment of FIG. 1B is described primarily with geo-location by WiFi tracking. However, other geo-location methods could be used in the environment of FIG. 1B.

In FIG. 1B, environment 10A is similar to the environment 10 of FIG. 1A and includes mobile media devices 26, advertiser 40, ad broker 30, analytics service 70, and retail store 80. Some components shown in FIG. 1B communicate over network 50. The ad broker 30, advertiser 40, and analytics service are described with respect to FIG. 1A.

The retail store 80 may be a physical structure that is related to the advertiser 40. For example, the retail store 80 may be a coffee shop, and the advertiser 40 may own and operate the retail store 80 and similar coffee shops in locations other than that of the retail store 80.

The retail store 80 includes WiFi access point 81 that establishes a WiFi boundary 84 (shown in dotted line) centered on the store 80. The WiFi access point 81 provides access to a WiFi network for certain media devices, including mobile media devices 26, which are capable of detecting a broadcast signal 86 from the WiFi access point 81.

In FIG. 1B, retail store 80 is shown with one WiFi access point. However, the retail store 80 may include multiple WiFi access points.

The WiFi access point 81 may be uniquely identified by a MAC address or SSID, for example. The unique identification of the WiFi access point 81 may be included in the signal 86 broadcast from the WiFi access point 81.

In FIG. 1B, mobile media device 26B and its operator 22B are shown approaching the retail store 80 and its corresponding WiFi boundary 84. During movement of the mobile media device 26B, and in other situations, certain personal information related to the operator 26B may be obtained as part of a mobile media advertising campaign.

FIG. 1C illustrates another environment in which a media consumption study including geo-locating of a mobile media device is enabled. In FIG. 1C, environment 10B includes a building 11, which is shown as a floor plan of a shopping center. Such a building may not allow reception of line of sight signals needed to receive accurate positions via satellite. However, and instead of WiFi access points, the building 11 may be equipped with a system of beacons or position markers that may be used in conjunction with accelerometers, gyroscopes, compasses, and device position constraints installed on mobile media device 26 to provide an accurate indoor device location. In an aspect, the position markers are RF transceivers 13 that are part of RFID system 12. The RF transceivers 13 may broadcast continually.

A RFID tag-equipped mobile media device 26 may enter building 11 via an entrance containing a RF transceiver 13. The RF signals may be detectable by the mobile media device's RFID tag. Thus, a RF transceiver 13 at the building entrance may detect entry of the mobile media device 26 (and consequently, operator 22). As the operator 22 moves through the building 11, other RFID transceivers 13 may broadcast signals that are answered by the RFID tag of the mobile media device 26. The detections of the mobile media device 26 may be provided to remote analytics server 72 (see FIG. 1A). The remote analytics server 72 may be programmed with the physical locations of the RF transceivers 13. Thus, the server 72 may be able to monitor the movement of the operator 22 through the building 11.

In some aspects, the mobile media device 26 may identify a location using a GPS receiver just prior to entering the interior of the building 11. This GPS location may then be used with accelerometer, gyroscope, compasses, and position marker information to provide an estimated interior location of the mobile media device 60 as the operator 22 traverses the building 11.

FIG. 2A illustrates an example video player displaying skippable advertisements. In FIG. 2A, video player 100 is shown displaying video 201 over which is displayed video advertisement 210. The video advertisement 210 may be displayed as a pre-roll video advertisement. The video advertisement 210 may be skipped by way of skip ad button 212. The skip ad button 212 may be displayed with an initial display of the video advertisement 210, but may not be activated until a specified time after the initial display. For example, the skip ad button may not be activated until the video ad 210 has played for 4 seconds. The skip ad button may persist until the video ad 210 ends and its selection at any time after 4 seconds may stop play of the video advertisement 210 and begin display of the video 201. In addition, should the video player 100 be closed, the browser move to another Web site, or other similar actions, the video advertisement 210 may cease playing.

Also shown in FIG. 2A is an overlay advertisement 220. The overlay advertisement 220 may not be displayed at a same time as the video advertisement 210. For example, the overly advertisement 220 may be displayed after the video advertisement 210 plays to completion or is skipped. The overlay advertisement 220 may include a dismiss button 222. Selection of the dismiss button 222 causes the overlay advertisement 220 to disappear from display.

FIG. 2B illustrates a mobile media device 26 that supports follow=on advertising and notification using, for example, WiFi-based geo-location and other locating processes. Mobile media device 26 includes memory interface 102, one or more data processors, image processors and/or processors 104, and peripherals interface 106. Memory interface 102, one or more processors 104 and/or peripherals interface 106 can be separate components or can be integrated in one or more integrated circuits. Processors 104 can include one or more application processors. The application processors may be integrated in one single process chip. The various components in mobile media device 26, for example, may be coupled by one or more communication buses or signal lines.

Sensors, devices, and systems (peripherals 105) are coupled to peripherals interface 106 to provide multiple functions. For example, motion sensor 110, light sensor 112, and proximity sensor 114 are coupled to peripherals interface 106 to facilitate orientation, lighting, and proximity functions of the mobile media device 26. Location processor 115 (e.g., a GPS receiver) provides geo-locating operations. Magnetometer 119 provides data that may be used to determine the direction of magnetic North. Thus, electronic magnetometer 119 may be used as an electronic compass. Accelerometer 117 provides data that may be used to determine change of speed and direction of movement of the mobile media device 26.

RFID tag 116, which may be a passive tag or an active tag, may be interrogated by an RF signal from a RF transmitter, and may send a signal in return with an identification (ID) unique to the mobile media device 26. The response signal may be an indication that the mobile media device 26 is in close proximity to the RF transmitter.

Camera system 121 and optical sensor 123 (e.g., a charged coupled device (CCD) or a complementary metal-oxide semiconductor (CMOS) optical sensor) provides camera functions, such as recording photographs and videos.

Communication functions are provided through one or more wireless communication systems 124, which may include radio frequency receivers and transmitters and/or optical (e.g., infrared) receivers and transmitters, and antenna 125. The specific design and implementation of a communication system 124 may depend on the communication network(s) over which a mobile media device 26 is intended to operate. For example, a mobile media device can include communication systems 124 designed to operate over a GSM network, a WiFi network, and a Bluetooth/Bluetooth Low Energy network.

Audio system 126 is coupled to speaker 128 and microphone 129 to provide voice-enabled functions, such as voice recognition, voice replication, digital recording, and telephony functions, and transmission and reception of acoustic signals outside the range of human hearing.

Input/Output (I/O) system 140 includes touch screen controller 142 and/or other input controller(s) 144. Touch-screen controller 142 is coupled to a touch screen 146 or pad. Touch screen 146 and touch screen controller 142 may, for example, detect contact and movement using touch sensitivity technologies. Other inputs may include a push-button key pad 148 and other buttons, including a hands free cradle button.

Memory interface 102 is coupled to memory 150. Memory 150 may include high-speed random access memory and/or non-volatile memory, such as one or more magnetic disk storage devices, one or more optical storage devices, and/or flash memory (e.g., NAND, NOR). Memory 150 may be connected to data store 151, which may store operating system 152, which in turn may include instructions for handling basic system services and for performing hardware dependent tasks.

Data store 151 also may store other instructions 154 including communication instructions to facilitate communicating with other media devices (fixed or mobile), one or more computers and/or one or more servers. The instructions 154 further may include graphical user interface instructions to facilitate graphical user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; magnetometer data and instructions to facilitate compass display and related functions. The data store 151 also may store one or more applications (not shown), such as a mobile banking application. Finally, the data store 151 stores location system 200.

As shown, notification system 250 includes event detection module 252, match module 258, and report module 262. The event detection module 252 determines if an event corresponding to a notification card occurs. For example, the module may determine a mobile media device is near or within the boundaries of a WiFi access point. In addition, the module 252 may determine if a time-based event has occurred, such as a the premier of a movie.

The match module 258 determines if the detected event matches any recorded in a notification card stored in local memory. If no matches are found, the module 258 may report the detected event to a remote server.

The report module 262 provides a report of actions taken by the viewer as indicated by operations executed on the mobile media device 26.

Each of the above identified instructions and applications can correspond to a set of instructions for performing one or more functions described above. These instructions need not be implemented as separate software programs, procedures, or modules. Furthermore, various functions of the mobile media device 26 may be implemented in hardware and/or in software, including in one or more application specific integrated circuits.

FIGS. 3A and 3B illustrate components of an example server-side system including hardware components 35 implemented on mobile media device 26 and/or remote server 74, and advertising system 300 for serving skippable and non-skippable ads, determining if a viewer has reacted to or interacted with an ad in a favorable manner (e.g., has shown an interest in the ad), and following up with the viewer. In an aspect, the follow up includes the system syndicating a follow up note, receiving a triggering event from the viewer's mobile media device, and providing a prompt or notice for display at the media device based on the follow up note and the triggering event.

As noted, the system may be implemented in a client-server relationship where some system components are located at a remote server such as the analytics server 74 and other components are located on individual mobile media devices such as mobile media device 26.

FIG. 3A illustrates an example of server-side components of an advertising system as disclosed herein. The system is instantiated on analytics server 74. The system includes hardware components of processor 75, memory 76, input/output (I/O) 77, data store 78, all of which are connected by communications and data bus 79. The data store 78 may include a tangible, computer-readable storage medium on which ad processing system 300 is implemented. The system 300 is described with respect to FIG. 3B.

In FIG. 3B, advertisement system 300 includes data acquisition module 310, event log/notification module 330, trigger/syndication module 350, conversion/reporting module 370, and pricing module 390.

The data acquisition module 310 receives data related to display and viewing of ads at a viewer's media devices, and the viewer's reaction to or interaction with the ads. In an embodiment, the data acquisition module 310 includes ad display detection engine 312 and ad reaction/interaction engine 314.

The engine 312 detects when a browser or other device on a media device accesses an Internet Web page having content that includes or links to a skippable ad. For example, a viewer may navigate to a video watch page to view current movie trailers. Before any movie trailer is displayed, a skippable ad may be displayed in a video player. The engine 312 detects the watch page as containing one or more videos with skippable ads. When the viewer selects a video containing a skippable ad, the ad may begin display, and the engine 312 receives a signal to the effect that a skippable ad is being displayed, whether the ad was skipped, and at what point in time of the ad such skipping occurred the length of time displayed (e.g., the engine 312 detects a viewer watching a skippable ad).

Ad reaction/interaction engine 314 detects an ad reaction/interaction operation initiated by a viewer. For example, the engine 314 may detect that a viewer has clicked on a soft “learn more” button provided with display of the video advertisement. Alternately, the soft button may link to an advertiser's Web page or to another, related advertisement. In yet another embodiment, the soft button may be a share button whereby the viewer “shares” the video advertisement with certain contacts in a social media system. The soft key may provide other functions that indicate a favorable reaction to the video advertisement.

Ad event log/notification module 330 includes notification engine 332. The notification engine 332 determines if the viewer's reactions/interactions warrant generation and storage of a notification card. The engine 332 determines if local memory on the mobile media device 26 has less than a threshold number of notification cards in storage. If the number of notification cards related to a particular equals or exceeds a threshold amount, or if the viewer's media device already contains notification cart related to the same advertisement, the engine 332 the modules 340 and/or the module 350.

Syndication module 340 syndicates (distributes) a notification card in response to certain triggering actions initiated by the viewer. The notification card may be sent to, and load into memory of each media device registered to the viewer. The notification card may be mapped to triggering actions, and the map and notification cards may be stored remotely with a remote server such as the server 74 of FIG. 1A. The notification card may update from time to time, with changes in its related ad, and the update notification card may be stored with the remote server.

Event detection module 350 may detect when the viewer's mobile media device triggers and event that causes display of the notification card. Examples of triggering events include proximity to a defined location such as a retail store and expiration of a timer. In the first example, the mobile media device may continually receive its geo-location by one of a number of mechanisms (GPS, for example) and may provide the geo-location to a suitably programmed processor in the mobile media device. The processor compares the received geo-location data to a geo-location stated in the notification card. If the locations match, the processor reads the notification card from memory and provides a display of its content for viewing by the viewer. Alternately, the mobile media device may receive a WiFi signal from a WiFi access point, the processor may compare the UI of the WiFi access points to a locally-stored database of such access points, and determine that the mobile media device is near or within the boundary of the WiFi access point. The processor then may display the information form the notification card.

In the second example, the notification card may include a timer. For example, the notification card may relate to an upcoming movie, and the notification card timer may be set to expire 24 hours before the movie's premier. When the timer expires, the processor may read the notification card and display a notification to the viewer that tickets to the movie are available. The notification also may include, or link to, a mechanism for completing a purchase of the movie tickets.

Conversion/reporting module 360 determines that a conversion occurs (e.g., a viewer enters a store, a viewer purchases a product). The module 360 may report this conversion to a remote entity.

Pricing module 370 determines and/or adjusts a price to be charged for showing an advertisement and further, for storing a notification card with the viewer.

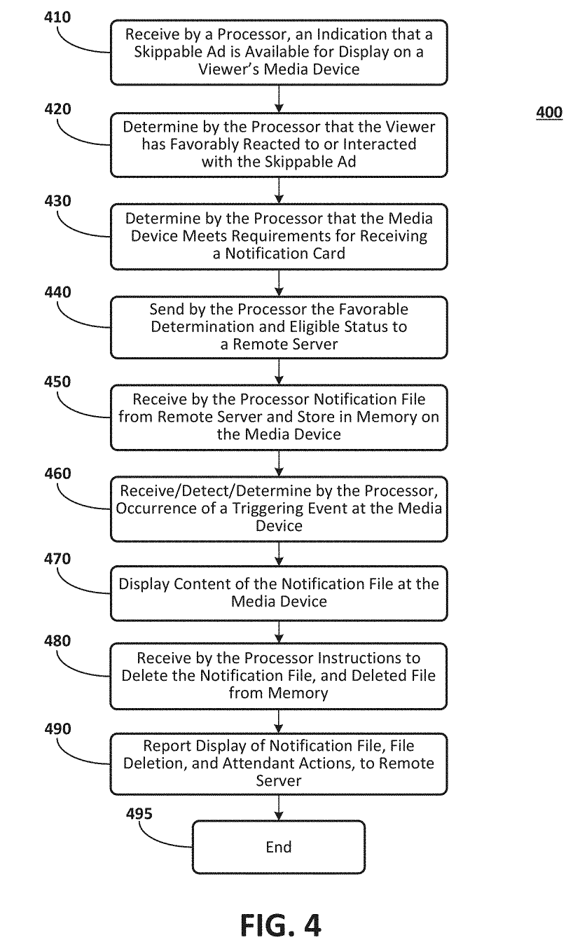

FIG. 4 is a flow chart illustrating an example method 400 for displaying skippable and non-skippable ads, determining actions taken in response to the displaying, and following up on actions taken in response to serving skippable and non-skippable advertisements.

Block 410: Receive by a processor, an indication that an ad is available for display on a viewer's media device.

Block 420: Determine by the processor that the viewer has favorably reacted to or interacted with the ad.

Block 430: Determine by the processor that the media device meets requirements for receiving a notification card.

Block 440: Send by the processor the favorable determination and eligible status to a remote server.

Block 450: Receive by the processor notification file from remote server and store in memory on the media device.

Block 460: Receive/detect/determine by the processor, occurrence of a triggering event at the media device.

Block 470: Display content of the notification file at the media device.

Block 480: Receive by the processor instructions to delete the notification file, and deleted file from memory.

Block 490: Report display of notification file, file deletion, and attendant actions, to remote server.

Block 495: Method 400 ends.

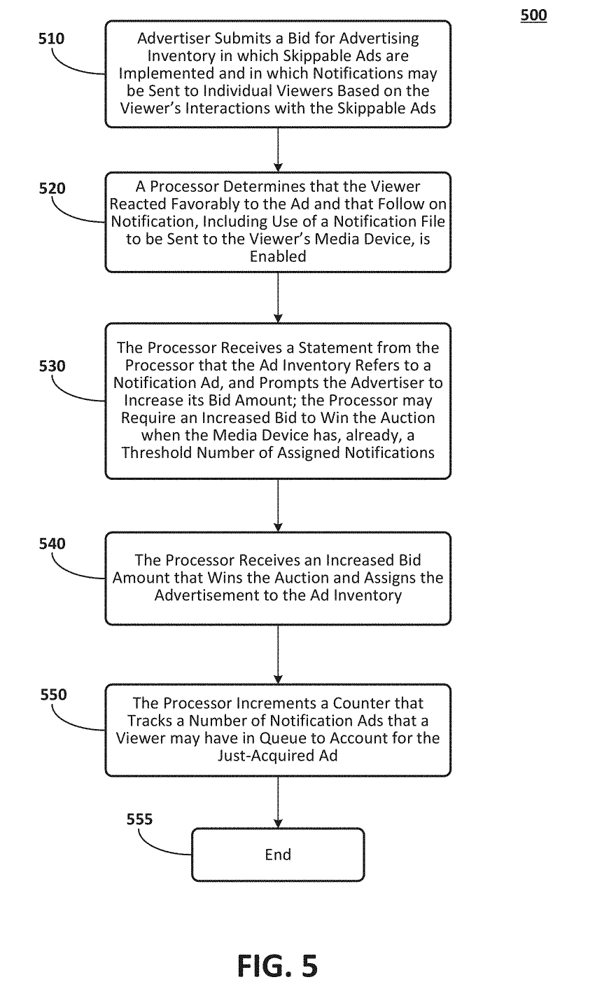

FIG. 5 is a flow chart illustrating an example method 500 for following up on actions taken in response to serving ads. In FIG. 5, method 500 begins in block 510 when an advertiser submits a bid for advertising inventory in which skippable and non-skippable ads are implemented and in which notifications may be sent to individual viewers based on the viewer's interactions with the skippable and non-skippable ads.

The method 500 continues:

Block 520: A processor determines that the viewer reacted favorably to the ad and that follow on notification, including use of a notification file to be sent to the viewer's media device, is enabled.

Block 530: The processor receives a statement from the processor that the ad inventory refers to a notification ad, and prompts the advertiser to increase its bid amount. In addition, the processor may require an increased bid to win the auction when the media device has, already, a threshold number of assigned notifications.

Block 540: The processor receives an increased bid amount that wins the auction and assigns the advertisement to the ad inventory.

Block 550: The processor increments a counter that tracks a number of notification ads that a viewer may have in queue to account for the just-acquired ad.

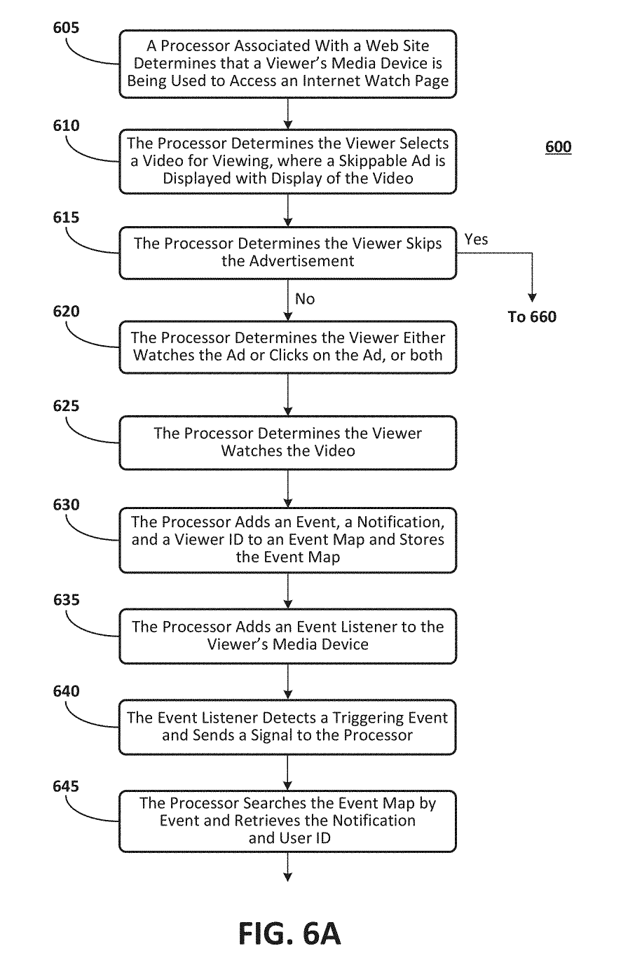

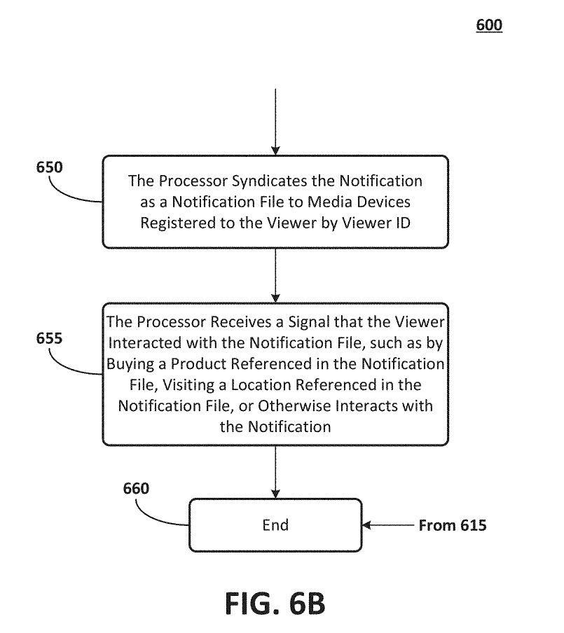

FIG. 6 is a flow chart illustrating example method 600 for serving skippable advertisements on a Web page, determining viewer interest in the skippable advertisements, providing notifications to the viewer, and determining and reporting interactions by the viewer with the interactions.

Block 605: A processor associated with a Web site determines that a viewer's media device is being used to access an Internet watch page. The Internet watch page includes in a series of videos, and each video may display one or more advertisements, including pre-roll video advertisements and overlay advertisements. One or more of the advertisements may include a skip feature. One or more of the ads may include an interactive feature.

Block 610: The processor determines the viewer selects a video for viewing, where a skippable ad is displayed with display of the video.

Block 615: The processor determines the viewer skips the advertisement. In this event, the method 600 moves to block 660 and ends.

Block 620: As an alternative to block 615, the processor determines the viewer either watches the ad or clicks on the ad, or both.

Block 625: The processor determines the viewer watches the video.

Block 630: The processor adds an event, a notification, and a viewer ID to an event map and stores the event map.

Block 635: The processor adds an event listener to the viewer's media device.

Block 640: The event listener detects a triggering event and sends a signal to the processor.

Block 645: The processor searches the event map by event and retrieves the notification and user ID.

Block 650: The processor syndicates the notification as a notification file to media devices registered to the viewer by viewer ID.

Block 655: The processor receives a signal that the viewer interacted with the notification file, such as by buying a product referenced in the notification file, visiting a location referenced in the notification file, or otherwise interacts with the notification.

Block 660: The method 600 ends.

The preceding description refers to example scenarios to illustrate the concepts disclosed herein. Another example scenario involves a channel creator who is interested in attracting viewers and inducing such viewers to subscribe to the channel. More subscribers may translate to more viewing of videos in the channel, and thus more opportunities for viewing monetizable content such as video ads accompanying the videos. To encourage viewers to subscribe, the channel creator may offer videos that represent the content of the channel in place of video ads that might otherwise be served on video watch pages. The herein disclosed systems may determine if a viewer reacts favorably to the channel creator's video. For example, a viewer may watch such a video through to conclusion, without scrolling, without muting, without minimizing, or without taking other actions indicating a lack of interest. These actions, or non-actions, by the viewer may indicate an interest in the channel. In those situations where a viewer reacts favorably to the channel creator's video, the systems may generate a notification card, and may send the notification card to the viewer when the channel creator uploads a new video for the channel. The notification may inform the viewer that a new video is available, provide a link to the video, and encourage the viewer to subscribe to the channel.

Certain of the devices shown in the figures include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flow charts and accompanying description to illustrate the embodiments represented in FIGS. 4-6. The disclosed devices, components, and systems contemplate using or implementing any suitable technique for performing the steps illustrated. Thus, FIGS. 4-6 are for illustration purposes only and the described or similar steps may be performed at any appropriate time, including concurrently, individually, or in combination. In addition, many of the steps in the flow chart may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

1. A computer-implemented method, comprising:
receiving, by a processor, an indication that a viewer has favorably reacted to an ad presented on a media device of the viewer;
determining, by the processor, that the media device is able to receive a specific type of notification file that is to be displayed on the media device in response to a triggering event;
in response to determining that the media device is able to receive the specific type of notification file, sending, by the processor, the indication that the viewer has favorably reacted to the ad and an indication that the media device is able to receive the specific type of notification file, to a remote server;
receiving, by the processor, a notification file corresponding to the specific type of notification file from the remote server;
determining whether a number of notification files stored on the media device exceeds a threshold;
in response to determining that the number of notification files stored on the media device does not exceed the threshold, causing the media device to store the notification file in a memory on the media device;
detecting, by the processor, occurrence of the triggering event at the media device;
in response to detecting the occurrence, causing content of the notification file to be displayed at the media device;
receiving an indication from the media device that the content of the notification file has been displayed; and
in response to receiving the indication, transmitting an instruction to the media device to delete the notification file from the memory.

2. (canceled)

3. The method of claim 1, further comprising reporting, by the processor, display of the notification file and the file deletion to the remote server.

4. The method of claim 1, wherein the notification files are stored in a queue at the remote server.

5. The method of claim 1, wherein the triggering event comprises a proximity of the media device to a known location.

6. The method of claim 5, wherein the known location comprises a WiFi access point, and wherein the media device determines its proximity to the WiFi access point and reports the proximity to the remote server.

7. The method of claim 1, wherein the triggering event comprises a time of occurrence of an event noted in the ad.

8. The method of claim 1, wherein the triggering event comprises accessing a Web site reference in the ad.

9. The method of claim 1, wherein the ad is a skippable ad.

10. The method of claim 9, wherein the skippable ad comprises a skip ad feature.

11-16. (canceled)

17. A non-transitory machine-readable storage medium including instructions that, when accessed by a processor, cause the processor to:
receive an indication of a favorable reaction to an advertisement displayed at a viewer's media device;
determine that the media device is able to receive a specific type of notification file that is to be displayed on the media device is response to a triggering event;
in response to determining that the media device is able to receive the specific type of notification file, send the indication that the viewer has favorably reacted to the ad and an indication that the media device is able to receive the specific type of notification file, to a remote server;
receive a notification file corresponding to the specific type of notification file from the remote server;
determine whether a number of notification files on the media device exceeds a threshold;
in response to determining that the number of notification files stored on the media device does not exceed the threshold, causing the media device to store the notification file in a memory on the media device;
detect an occurrence of the triggering event at the media device;
in response to the detecting the occurrence, cause the notification file to be displayed on the media device;
receive an indication from the media device that the notification file has been displayed; and
in response to receiving the indication, transmit an instruction to the media device to delete the notification file from the memory.

18. The non-transitory machine-readable storage medium of claim 17, wherein the ad comprises a skippable video ad and wherein the processor is further to determine the skippable video ad was not skipped.

19. The non-transitory machine-readable storage medium of claim 17, wherein the ad comprises a non-skippable ad and wherein the processor is further to determine occurrence of an ad click on operation during display of the non-skippable ad.

20. The non-transitory machine-readable storage medium of claim 17, wherein the triggering event comprises at least one of a proximity to a defined location or an expiration of a timer.

21. A system, comprising:
a first memory to store a notification file;
a processor, operatively coupled to the memory, the processor to:
receive an indication of a favorable reaction to an advertisement displayed at a viewer's media device;
determine that the media device is able to receive a specific type of notification file that is to be displayed on the media device is response to a triggering event;
in response to determining that the media device is able to receive the specific type of notification file, send the indication that the viewer has favorably reacted to the ad and an indication that the media device is able to receive the specific type of notification file, to a remote server;
receive a notification file corresponding to the specific type of notification file from the remote server;
determine whether a number of notification files on the media device exceeds a threshold;
in response to determining that the number of notification files stored on the media device does not exceed the threshold, causing the media device to store the notification file in a second memory on the media device;
detect an occurrence of the triggering event at the media device;
in response to the detecting the occurrence, cause the notification file to be displayed on the media device;
receive an indication from the media device that the notification file has been displayed; and
in response to receiving the indication, transmit an instruction to the media device to delete the notification file from the second memory.

22. The system of claim 21, the processor further to:
receive instructions to delete the notification file from the remote server; and
delete the notification file from the first memory.

23. The system of claim 22, the processor further to report display of the notification file and the file deletion to the remote server.

24. The system of claim 21, wherein the ad comprises a skippable video ad and wherein the processor is further to determine the skippable video ad was not skipped.

25. The system of claim 21, wherein the ad comprises a non-skippable ad and wherein the processor is further to determine occurrence of an ad click on operation during display of the non-skippable ad.

26. The system of claim 21, wherein the triggering event comprises at least one of a proximity to a defined location or an expiration of a timer.
